(19) United States
(12) Patent Application Publication
(10) Pub. No.: US 2019/0147136 A1
(43) Pub. Date: May 16, 2019

(54) Method of Using Machine Learning Algorithms in Analyzing Laboratory Test Results of Body Fluid to Detect Microbes in the Body Fluid

(71) Applicants: Jang-Jih Lu, Taipei City (TW); Chung-Chih Hung, Taipei City (TW); Hsin-Yao Wang, Chiayi City (TW); Yi-Ju Tseng, Taoyuan City (TW)

(72) Inventors: Jang-Jih Lu, Taipei City (TW); Chung-Chih Hung, Taipei City (TW); Hsin-Yao Wang, Chiayi City (TW); Yi-Ju Tseng, Taoyuan City (TW)

(73) Assignees: CHANG GUNG MEMORIAL HOSPITAL, LINKOU, Taoyuan City (TW); Chang Gung University, Taoyuan City (TW)

(21) Appl. No.: 15/810,274

(22) Filed: Nov. 13, 2017

(51) Int. Cl. G06F 19/24; G06K 9/62; G06F 15/18

(52) U.S. Cl. CPC G06F 19/24; G06F 15/18; G06K 9/6269; G06K 9/6282

(57) ABSTRACT

A method of using machine learning algorithms in analyzing laboratory test results of body fluid to detect microbes in the body fluid includes using a body fluid detection module for analytic measurements in body fluid of a person to create biological samples; sending the biological samples of a plurality of persons and corresponding microbes infection statuses to perform machine learning algorithms to establish a microbes in body fluid prediction model; and sending data obtained from the body fluid detection of a patient for testing to the microbes in body fluid prediction model for operation and analysis in order to determine whether the microbes is present in body fluid.

### BACKGROUND OF THE INVENTION

### 1. Field of the Invention

The invention relates to a method of detecting infected microbes in the body fluid, and more particularly to a method of using machine learning algorithms in analyzing laboratory test results of body fluid to detect microbes in the body fluid, the method being capable of determining whether the microbes in body fluid are infected with greatly increased success rate.

### 2. Description of Related Art

Diseases caused by infectious microbes in body fluid can be serious. However, the conventional apparatuses for detecting microbes in body fluid have a low performance. It is often that the test results show the symptoms being false-negative after detecting microbes in body fluid by using the conventional detection apparatus.

In other words, the microbes causing the infection cannot be detected. This is particularly true for persons having no symptoms. And in turn, a physician may not pay attention to the person when examining the person.

Conventionally, a manual screening test is used to detect microbes in body fluid. However, it is time consuming especially for a large hospital since there are many patients taking part in the screening test. As to conventional automatic screening apparatuses, they do not have the function of detecting microbes in body fluid.

Thus, the need for improvement still exists.

### SUMMARY OF THE INVENTION

It is therefore one object of the invention to provide a method of using machine learning algorithms in analyzing laboratory tests results of body fluid to detect microbes in the body fluid comprising the steps of (a) body fluid detection: using a body fluid detection module for analytic measurement in body fluid of a person for testing to create biological samples; (b) machine learning model establishment: sending the biological samples of a plurality of persons and corresponding microbes infection statuses to a machine learning apparatus which performs machine learning algorithms to establish a microbes in body fluid prediction model; and (c) microbes in body fluid prediction model analysis: sending data obtained from the body fluid detection of a patient for testing to the microbes in body fluid prediction model for operation and analysis in order to determine whether the microbes is present in body fluid.

Preferably, further comprises the step of verification of detected microbes including after determining the infected microbes by analyzing the microbes in body fluid prediction model, using a microbes verification technique on the biological samples infected by microbes for verification.

Preferably, the microbes verification technique includes using a microscope, an immunity analysis method of antibody antigen reaction, a polymerase chain reaction (PCR), microbes culture method, or any combinations thereof.

Wherein the microbes infection statuses could be classified into “infection” and “non-infection”, or by the degree of severity of the infection, and the machine learning model performs feature selection, selecting a plurality of robust variables and the corresponding microbes infection statuses.

Preferably, the body fluid is blood, urine, saliva, sweat, feces, pleural fluid, ascites fluid or cerebrospinal fluid.

Preferably, markers used in step (a) of body fluid detection include total Protein, Albumin, Leukocyte Esterase, C-Reactive Protein, Procalcitonin, Erythrocyte Sedimentation Rate, Lactate, Lactate Dehydrogenase, Sugar, Na, K, Ca, Cl, Mg, Fe2+, Fe3+, Urea Nitrogen, Creatinine, Cystatin C, Bilirubin, Urobilinogen, Urobilin, Stercobilin, Specific Gravity, Osmolality, Ketone, pH, Nitrite, Occult Blood, Red Blood Cells Counts, White Blood Cells Counts, Epithelial cells Counts, Cholesterol, Amylase, Cast, Crystal, and any combinations thereof.

Preferably, the machine learning algorithms include Logistic Regression (LR), k-nearest neighbors (kNN), Support Vector Machines (SVM), Artificial Neuron Network, Decision Tree, Random Forest, Bayesian Network, and any combinations thereof.

The invention has the following advantages and benefits in comparison with the conventional art: greatly increasing the rate of successfully detecting Trichomonas vaginalis in the body fluid, and capable of reminding medical personnel to use microbes verification technique for screening the samples so that the medical personnel may perform the microbes verification technique to only screen the samples having a high possibility of being infected by microbes, thereby avoiding screening all samples, and thereby greatly increasing the success rate of screening samples, and greatly saving time and cost.

The above and other objects, features and advantages of the invention will become apparent from the following detailed description taken with the accompanying drawings.

### BRIEF DESCRIPTION OF THE DRAWINGS

FIG. 1 is a flow chart diagram of a method of using machine learning algorithms in analyzing laboratory test results of body fluid to detect microbes in the body fluid according to a first preferred embodiment of the invention;

FIG. 2 is a flow chart diagram of a method of using machine learning algorithms in analyzing laboratory test results of body fluid to detect microbes in the body fluid according to a second preferred embodiment of the invention;

FIG. 3 shows a first chart of AUC versus random forest, LR and SVM for female and a second chart of AUC versus random forest, LR and SVM for male according to the invention; and

FIG. 4 shows a first chart of improved performance versus 20-unit and random forest for female, a second chart of improved performance versus 20-unit and LR for female, a third chart of improved performance versus 20-unit and SVM for female, a fourth chart of improved performance versus 20-unit and random forest for male, a fifth chart of improved performance versus 20-unit and LR for male, and a sixth chart of improved performance versus 20-unit and SVM for male according to the invention.

### DETAILED DESCRIPTION OF THE INVENTION

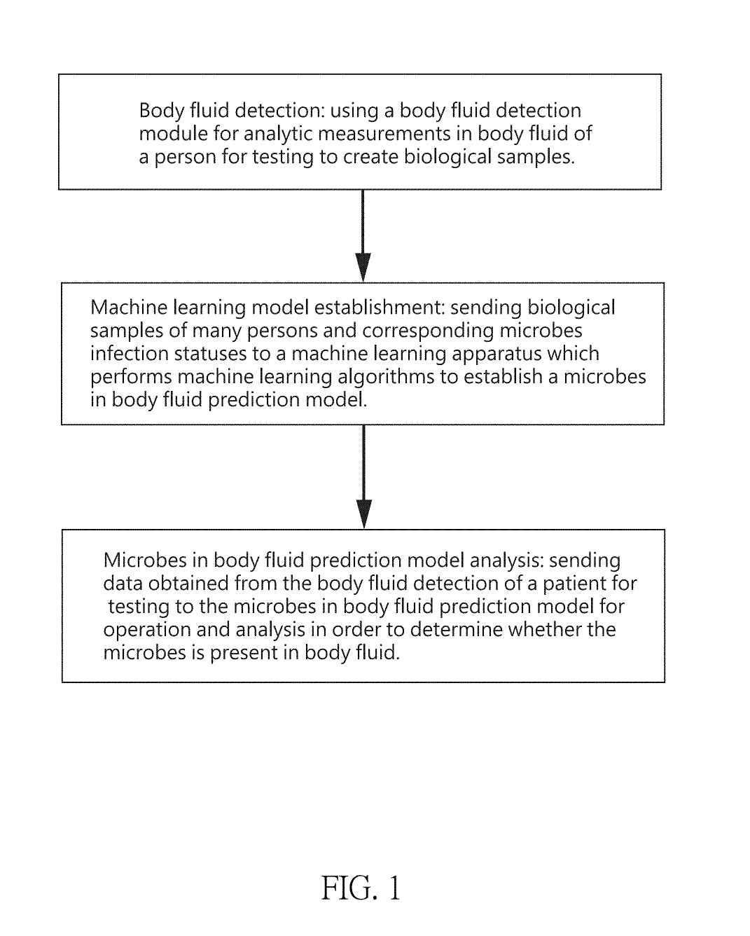

Referring to FIG. 1, a flow chart of a method of using machine learning algorithms in analyzing laboratory test results of body fluid to detect microbes in the body fluid in accordance with a first preferred embodiment of the invention is illustrated.

The body fluid is blood, urine, saliva, sweat, feces, chest water, abdominal water or spinal fluid.

The machine learning algorithms include LR, kNN, SVM, Artificial Neuron Network, Decision Tree, Random Forest, Bayesian Network, and any combinations thereof.

The method comprises the following steps:

Body fluid detection: using a body fluid detection module for analytic measurements in body fluid of a person for testing to create biological samples.

Markers used in the body fluid detection include total Protein, Albumin, Leukocyte Esterase, C-Reactive Protein, Procalcitonin, Erythrocyte Sedimentation Rate, Lactate, Lactate Dehydrogenase, Sugar, Na, K, Ca, Cl, Mg, Fe2+, Fe3+, Urea Nitrogen, Creatinine, Cystatin C, Bilirubin, Urobilinogen, Urobilin, Stercobilin, Specific Gravity, Osmolality, Ketone, pH, Nitrite, Occult Blood, Red Blood Cells Counts, White Blood Cells Counts, Epithelial cells Counts, Cholesterol, Amylase, Cast, Crystal, and any combinations thereof.

Machine learning model establishment: sending biological samples of many persons and corresponding microbes infection statuses to a machine learning apparatus which performs machine learning algorithms to establish a microbes in body fluid prediction model.

Wherein the machine learning model performs feature selection, selecting a plurality of robust variables and the corresponding microbes infection statuses, and then, the machine learning apparatus performs machine learning algorithms to establish a microbes in body fluid prediction model.

Wherein the microbes infection statuses could be classified into “infection” and “non-infection”, or by the degree of severity of the infection

Microbes in body fluid prediction model analysis: sending data obtained from the body fluid detection of a patient for testing to the microbes in body fluid prediction model for operation and analysis in order to determine whether the microbes is present in body fluid.

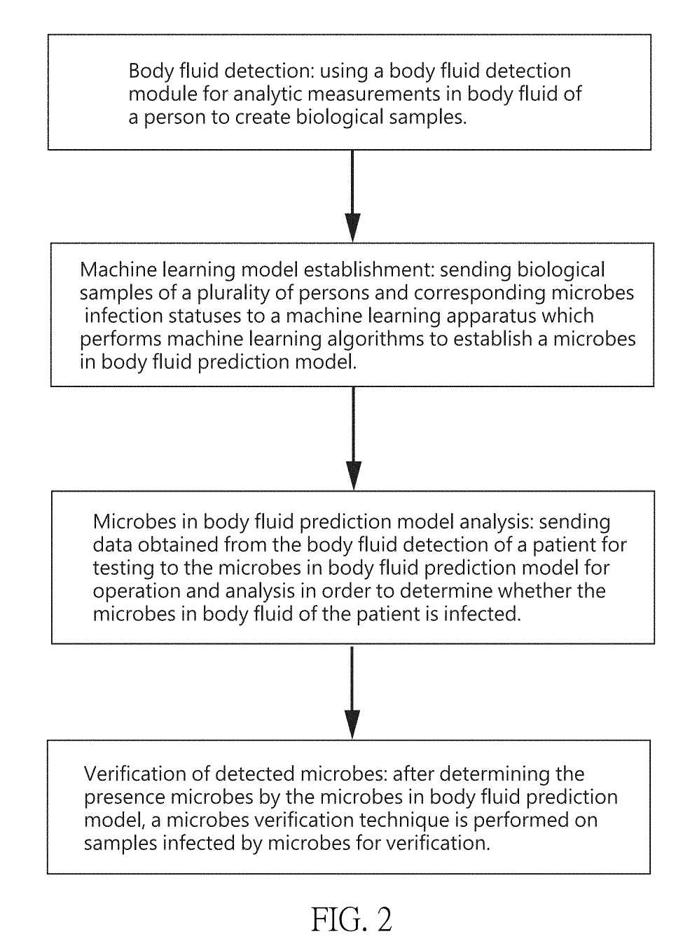

Referring to FIG. 2, a flow chart of a method of using machine learning algorithms in analyzing laboratory test results of body fluid to detect microbes in the body fluid in accordance with a second preferred embodiment of the invention is illustrated. The method comprises the following steps:

Body fluid detection: using a body fluid detection module for analytic measurements in body fluid of a person to create biological samples.

Machine learning model establishment: sending biological samples of a plurality of persons and corresponding microbes infection statuses to a machine learning apparatus which performs machine learning algorithms to establish a microbes in body fluid prediction model.

Microbes in body fluid prediction model analysis: sending data obtained from the body fluid detection of a patient for testing to the microbes in body fluid prediction model for operation and analysis in order to determine whether the microbes in body fluid of the patient is infected.

Verification of detected microbes: after determining the presence microbes by the microbes in body fluid prediction model, a microbes verification technique is performed on samples infected by microbes for verification.

The microbes verification technique includes using a microscope, an immunity analysis method of antibody antigen reaction, a polymerase chain reaction (PCR), microbes culture method, and any combinations thereof.

The samples infected by microbes determined by the microbes in body fluid prediction model analysis are used to remind medical personnel to use microbes verification technique for further confirmation of microbes in the samples. Therefore, the medical personnel may perform the microbes verification technique on only the samples having a high possibility of being infected by microbes. This has the benefit of avoiding performing microbes verification technique on all samples for confirmation of microbes. And in turn, it has the advantages of greatly increasing the success rate of screening samples, and greatly saving time and cost. Benefits, advantages and inventiveness of the invention are detailed below.

In Microbes verification technique, for example, a microscope is being used, and the verification can be performed on each of 600 samples per day.

Samples being centrifuged before verification: 20 samples are centrifuged together simultaneously, so that there would be 30 centrifugations per day. Each of the centrifugation consumes 5 minutes. Preparation and observation: one minute per sample.

Total time spent on the above verification technique per day: (30×5)+600=750 minutes

Mechanical learning, according to the invention, can decrease 95% of samples to be tested by verification technique. The total samples needed to be confirmed by verification technique could be reduced to 30 samples per day.

While there are 30 samples to test, 2 samples will be centrifuged together at once, the total centrifugation would be reduced to 15 times. Each of the centrifugation consumes five minutes.

Preparation and observation: one minute per test tube.

Total time spent per day: (15×5)+30=105 minutes

In comparison with the conventional method, the method of the invention can decrease 645 minutes per day in terms of work hour. It is abundantly clear that medical personnel can effectively and efficiently identify microbes in the body fluid by taking advantage of the method of the invention.

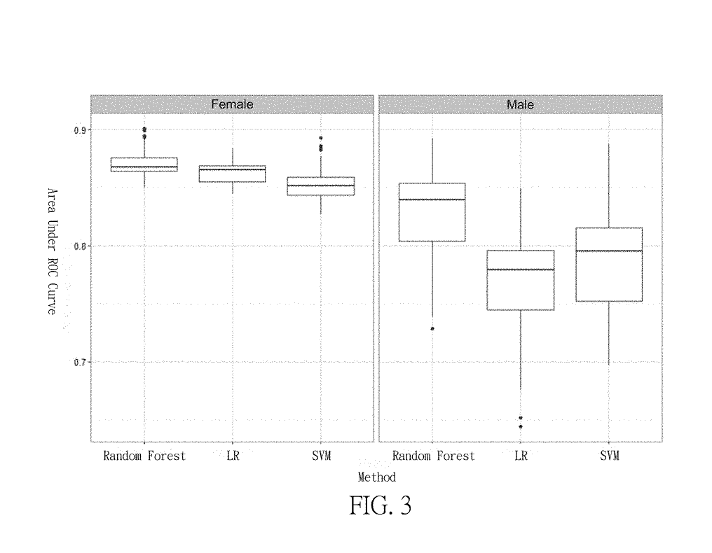

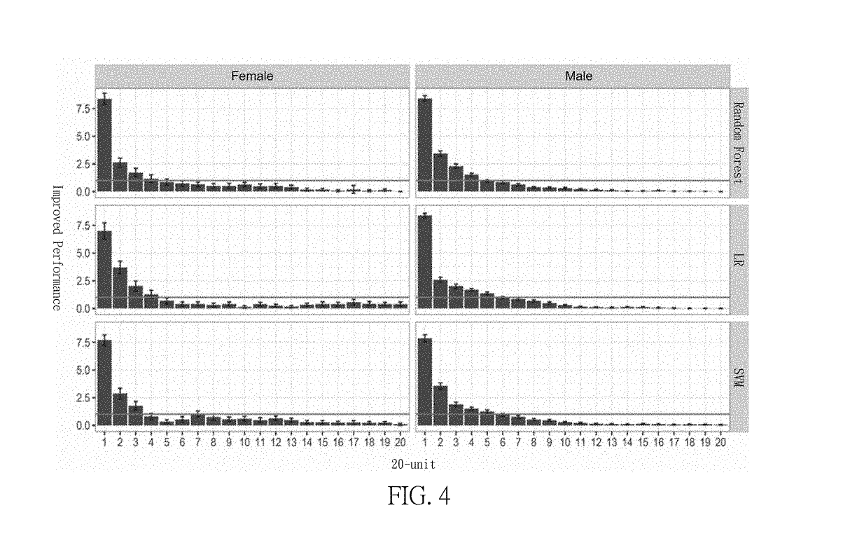

Referring to FIGS. 3 and 4, embodiments and applications of the method of using machine learning algorithms in establishing model for detecting parasite Trichomonas vaginalis which causes trichomoniasis are discussed below. Trichomonas vaginalis is a sexually transmitted diseases (STD). Trichomonas vaginalis is the most infectious form of STD based on WHO data released in 2008 and there are more than 276 million people infected by Trichomonas vaginalis worldwide. There are 3.7 million people infected by Trichomonas vaginalis in US. About 70% of women and men do not have symptoms when infected. When symptoms do occur, they typically begin 5 to 28 days after exposure. Trichomoniasis occurs more often in women than men. Trichomoniasis occurs more often in older women than in younger women. Medical personnel can test urine to find Trichomonas vaginalis and thus can provide an early diagnosis and cure. As technologies advance and test apparatuses are automated, test time can be greatly reduced, labor can be saved, the number of test steps can be greatly decreased, and performance can be efectively improved. However, automatic urine test apparatuses are not capable of detecting microbes in urine. In research report released by a reference hospital center in Taiwan, it is found that the percentage of detecting Trichomonas vaginalis by means of a conventional centrifugal screening apparatus is 0.6% and disadvantageously the percentage of detecting Trichomonas vaginalis by an automatic urine test apparatus is greatly decreased to 0.15%. Therefore, how to deal with low detection percentage of Trichomonas vaginalis by automatic urine test apparatuses has become critical issues in clinical medicine.

Test method is discussed below.

1) Requirements (e.g., admission and exclusion conditions) for person for testing and number of samples: A complete report of urine test of a person for testing includes chemical test results of urine and sediment results of urine. In the embodiment, the report of body fluid test is written based on medical records of many patients. The number of samples is 800,000 for the complete report of urine test.

2) Design and method: Measurements include seven parameters of urine test results. The report of urine test is classified based on whether there is Trichomonas vaginalis in the urine.

2-1) Feature selection: After preliminary data cleaning, the embodiment performs feature selection, choosing proper univariate statistics (e.g. Chi-square test. The age, leukocyte esterase, urine protein, leukocyte, or epithelial cells could be selected as the feature for the model training.

2-2) Model training After finishing the report of urine test, a plurality of learning models including logistic regression (LR), support vector machine (SVM), and random forest for monitor are established in the embodiment. Patients satisfying the inclusion criteria were randomly assigned to one of five folds. We used a 5-fold cross-validation approach to train (four folds) and test (one fold) the models. Another 5-fold cross-validation process was conducted to tune the classification model in the training step.

3) Period of the embodiment: from Jan. 1, 2009 to Dec. 31, 2013.

4) Evaluation of test results and statistics: In the embodiment, receiver operating characteristic (ROC) curve and lift are used for evaluating performance, and area under ROC (AUC) curve is obtained by calculation.

In FIG. 3, a first chart of AUC versus random forest, LR and SVM for female and a second chart of AUC versus Random Forest, LR and SVM for male are shown. It is found that capability of detecting Trichomonas vaginalis in urine of the method of the invention is very good.

In FIG. 4, a first chart of improved performance versus 20-unit and random forest for female, a second chart of improved performance versus 20-unit and LR for female, a third chart of improved performance versus 20-unit and SVM for female, a fourth chart of improved performance versus 20-unit and random forest for male, a fifth chart of improved performance versus 20-unit and LR for male, and a sixth chart of improved performance versus 20-unit and SVM for male are shown. It is found that capability of screening Trichomonas vaginalis in urine of the method of the invention is very good. In comparison with the conventional manual screening method, the method of the invention can increase the rate of successfully detecting Trichomonas vaginalis in urine to about seven times with respect to high risk persons, irrespective of males or females, of the persons for testing (about 5%)

In view of the above discussion, the method of using machine learning algorithms in analyzing laboratory test results of body fluid to detect microbes in the body fluid of the invention can greatly increase the rate of successfully detecting Trichomonas vaginalis in the body fluid (e.g., urine), as shown in the AUCs of FIG. 3 and FIG. 4.

While the invention has been described in terms of preferred embodiments, those skilled in the art will recognize that the invention can be practiced with modifications within the spirit and scope of the appended claims.

What is claimed is:

1. A method of using machine learning algorithms in analyzing laboratory test results of body fluid to detect microbes in the body fluid comprising the steps of:
(a) a body fluid detection comprising using a body fluid detection module for analytic measurements in body fluid of a person to create biological samples;
(b) a machine learning model establishment comprising sending the biological samples of a plurality of persons and corresponding microbes infection statuses to perform machine learning algorithms to establish a microbes in body fluid prediction model; and
(c) a microbes in body fluid prediction model analysis comprising sending data obtained from body fluid analytic measurements of a patient for testing to the microbes in body fluid prediction model for operation and analysis in order to determine whether the microbes is present in body fluid.

2. The method of claim 1, further comprising the step of verifying microbes in body fluid of the patient, after determining the presence of microbes by the microbes in body fluid prediction model, using a microbes verification technique on biological samples of the patient for verification.

3. The method of claim 2, wherein the microbes verification technique comprises a microscope, an immunity analysis method of antibody antigen reaction, a polymerase chain reaction (PCR), microbes culture method, and any combinations thereof.

4. The method of claim 1, wherein the microbes infection statuses comprises classifying into infection and non-infection, or by the degree of severity of the infection, and the machine learning model performs feature selection selecting a plurality of robust variables and the corresponding microbes infection statuses.

5. The method of claim 1, wherein the body fluid includes blood, urine, saliva, sweat, feces, pleural fluid, ascites fluid or cerebrospinal fluid.

6. The method of claim 1, wherein markers used in step (a) of body fluid detection include total Protein, Albumin, Leukocyte Esterase, C-Reactive Protein, Procalcitonin, Erythrocyte Sedimentation Rate, Lactate, Lactate Dehydrogenase, Sugar, Na, K, Ca, Cl, Mg, Fe2+, Fe3+, Urea Nitrogen, Creatinine, Cystatin C, Bilirubin, Urobilinogen, Urobilin, Stercobilin, Specific Gravity, Osmolality, Ketone, pH, Nitrite, Occult Blood, Red Blood Cells Counts, White Blood Cells Counts, Epithelial cells Counts, Cholesterol, Amylase, Cast, Crystal, and any combinations thereof.

7. The method of claim 1, wherein the machine learning algorithms include Logistic Regression, k-Nearest Neighbor, Support Vector Machine, Artificial Neuron Network, Decision Tree, Random Forest, Bayesian Network, and any combinations thereof.
